(19) United States
(12) Patent Application Publication
(10) Pub. No.: US 2003/0095917 A1
(43) Pub. Date: May 22, 2003

(54) Chemical composition and process

(76) Inventors: Debra Wilcox, Ethelsville, AL (US); Mikael Siverstrom, Partille (SE); Gunilla Jadesjo, Kungalv (SE)

Correspondence Address: David J. Serbin, Unit 2, First Floor, 1423 Powhatan Street, Alexandria, VA, 22314, US

(21) Appl. No.: 10/205,468

(22) Filed: Jul. 26, 2002

Related U.S. Application Data
(60) Provisional application No. 60/307,862, filed on Jul. 27, 2001.

(51) Int. Cl. C01B 15/037; C01B 11/02

(52) U.S. Cl. 423/584; 423/272; 423/478

(57) ABSTRACT

The invention relates to an aqueous composition of, up to about 90 wt %, hydrogen peroxide, comprising from about 0.05 to about 20 mmol/kg H₂O₂ of amino tri (methylenephosphonic acid), or salts or degradation products thereof, and a corrosion corrosion inhibitor, being either substantially free from or containing less than about 0.1 mole/l chlorate ions, having a tin content from 0 to about 100 mg/kg H₂O₂, and having a chloride content less than about 10 mg Cl⁻kg H₂O₂. The invention also relates to a process for producing chlorine dioxide where said composition is used as a feed.

The present invention relates to an aqueous composition of hydrogen peroxide and a process where an aqueous composition of hydrogen peroxide is used for producing chlorine dioxide.

Hydrogen peroxide is usually present on the market as aqueous solutions in various concentrations. Hydrogen peroxide is very sensitive to contaminants, which may promote decomposition and inefficient reactions. Such contaminants are, for example, dissolved metal cations. Metal containers and tanks are commonly used for transport and storage of hydrogen peroxide solutions. Through corrosive processes, metals in contact with hydrogen peroxide solutions may release metal cations, which may accelerate the decomposition of hydrogen peroxide. Also, the storage tank may be damaged. Metal cations may also form insoluble salts, or a precipitation, which may further increase the corrosion rate.

Thus, an important property for a hydrogen peroxide solution is low corrosion to metals, especially to stainless steel, aluminium and aluminium-based alloys, since they are commonly used as materials in transport vessels and storage tanks. The main drawback with aluminium corrosion is the damage it may cause on the storage tank itself while the metal cations released from stainless steel material affects the stability of hydrogen peroxide. The stability of a hydrogen peroxide solution may be improved by adding certain stabilising additives. Important properties for such additives, besides a good function as a stabiliser, are long-term stability in hydrogen peroxide and no disturbing effects in different applications where hydrogen peroxide is used, such as chlorine dioxide generation and organic peroxide production. Discoloration of hydrogen peroxide solutions may occur during storage, especially when higher amounts of organic impurities are present. It is desired that the colour of a hydrogen peroxide solution does not change during storage or use.

Numerous stabilisers have been suggested for hydrogen peroxide compositions. U.S. Pat. No. 4,606,905 discloses a process for production of hydrogen peroxide where an aqueous solution of diethylene triamine penta (methylenephosphonic acid) (DTPMP) is used during the oxidation and extraction phases to reduce corrosion. WO 00/76916 discloses a composition, optionally including phosphonic acids, useful as feed for production of chlorine dioxide. RU 2049722 discloses a method for stabilising highly concentrated solutions of hydrogen peroxide by using acetic acid and a choice of phosphonates. CA 2144468, U.S. Pat. No. 5,273,733 and U.S. Pat. No. 5,545,389 disclose that hydrogen peroxide containing various phosphonates can be used for production of chlorine dioxide.

It is an object of the present invention to provide an aqueous hydrogen peroxide composition, which is both storage stable and low corrosive, at the same time as other important properties mentioned above are achieved. It is another object of the invention to provide a process for production of chlorine dioxide where a novel aqueous hydrogen peroxide composition is used as a feed.

It has surprisingly been found possible to meet these objects by a new aqueous composition of, up to about 90 wt %, hydrogen peroxide, comprising from about 0.05 to about 20 mmol/kg H₂O₂ of amino tri (methylenephosphonic acid) (ATMP), or salts or degradation products thereof, and a corrosion inhibitor, and having a chloride content of less than about 10 mg Cl⁻/kg H₂O₂.

It is surprising that a composition as described above comprising ATMP in combination with low chloride content gives very low corrosion since a composition comprising DTPMP, having the same chloride levels does not. The composition comprising ATMP also gives lower corrosion than a composition comprising 1-hydroxy-ethane-1,1-diphosphonic acid (HEDP), another stabiliser available on the market that may be used for hydrogen peroxide stabilisation.

Furthermore, compositions of DTPMP or HEDP having the low levels of chloride according to the present invention do not respond to added corrosion inhibitor.

The TOC (total organic carbon) values of hydrogen peroxide solutions typically range from 60 to 500 mg/l depending on the grade of hydrogen peroxide. Especially at high TOC values, the colour of a hydrogen peroxide solution may get darker during storage. It has surprisingly been found that the colour of a hydrogen peroxide composition according to the present invention remains stable also at a high value of total organic carbon (TOC) while a significant discoloration appears when DTPMP is used instead.

The amount of ATMP, or salts or degradation products thereof in the composition is form about 0.05 to about 20 mmol/kg H₂O₂, preferably from about 0.1 to about 10 mmol/kg H₂O₂, most preferably from about 0.2 to about 5 mmol/kg H₂O₂. Due to mechanisms not fully known, phosphonates in higher amounts seem to increase corrosion.

The chloride content in the composition is less than about 10 mg Cl⁻/kg H₂O₂, preferably from 0 to about 2 mg Cl⁻/kg H₂O₂, most preferably from 0 to about 0.8 mg Cl⁻/kg H₂O₂.

The composition additionally comprises a corrosion inhibitor in a suitable amount. The corrosion inhibitor is preferably a nitrate salt, most preferably a nitrate salt selected from the group of ammonium nitrate and alkali metal nitrate, such as sodium nitrate and potassium nitrate. The nitrate content is preferably from about 50 to about 1500 mg NO₃ /kg H₂O₂, most preferably from about 100 to about 700 mg NO₃ ⁻/kg H₂O₂.

Furthermore, the hydrogen peroxide composition may comprise phosphoric acid in a content from about 5 to about 4000 mg/kg H₂O₂, preferably from about 10 to about 2000 mg/kg H₂O₂, most preferably from about 50 to about 500 mg/kg H₂O₂.

The concentration of hydrogen peroxide is up to about 90 wt %, suitably from about 10 to about 85 wt %, preferably from about 15 to about 70 wt %, most preferably from about 20 to about 50 wt %.

Tin, as alkali metal stannate, is sometimes used in combinations with phosphonates to stabilise hydrogen peroxide solutions. However, stannate may form a precipitation with some metal ions such as Al²⁺, Fe²⁺, Mg²⁺ which may lead to corrosion processes on metal surfaces covered by such precipitation, especially in aluminium based materials. Another disadvantage for tin is seen when producing chlorine dioxide from a hydrogen peroxide solution and chlorate, where a stannate stabilised hydrogen peroxide solution gives foaming problems. Thus, the content of tin should be kept low. The content of tin is from 0 to about 100 mg Sn/kg H₂O₂, preferably from 0 to about 40 mg Sn/kg H₂O₂, more preferably from about 0 to about 20 mg Sn/kg H₂O₂, even more preferably from about 0 to about 10 mg Sn/kg H₂O₂, most preferably tin should be substantially absent in the composition.

The composition according to the invention has suitably a low content of chlorate and chloric acid. The composition is either substantially free from or contains less than about 0.1 mole/l chlorate ions, preferably less than about 0.01 mole/l, more preferably less than about 0.001 mole/l, most preferably the composition is substantially free from chlorate ions.

The pH of the composition is suitably from about −2 to about 6, preferably from about −1 to about 5, more preferably from about 0 to about 4, most preferably from about 0.5 to about 3.

The dry residue in the composition, with added ATMP deducted and added corrosion inhibitor deducted, is suitably from 0 to about 800 mg/kg, preferably from about 10 to about 600 mg/kg, most preferably from about 20 to about 500 mg/kg.

The invention further concerns a process for producing chlorine dioxide from hydrogen peroxide and metal chlorate, or chloric acid, comprising a step of feeding to a reaction zone metal chlorate or chloric acid and a composition as described above. The composition according to the invention can be applied to any known chlorine dioxide production process using hydrogen peroxide as one feed including those described in e.g. U.S. Pat. No. 5,091,166, U.S. Pat. No. 5,091,167, U.S. Pat. No. 5,380,517 and U.S. Pat. No. 5,545,389. Preferred processes include feeding alkali metal chlorate, a mineral acid and a composition of the invention to an acidic reaction medium in the reaction zone and withdrawing chlorine dioxide as a gas, preferably together with either water vapour boiling off from the reaction medium or inert gas injected into the reaction medium. Alkali metal salt of the mineral acid may be withdrawn as a solid salt cake or as an acidic residual solution. Further details appear in the above mentioned patents. It has been found that the composition of the invention works well in the above-mentioned processes giving no significant foaming problems and without disturbing the reactions.

The invention will now further be described in connection with the following examples, which, however, not should be interpreted as limiting the scope of the invention.

### EXAMPLE 1

Three phosphonate complex forming agents were tested for corrosion in hydrogen peroxide: DTPMP, HEDP and ATMP. Depending on the pH, the relation phosphonic acid/phosphonate will vary. Probes of metallic materials, aluminium and stainless steel, were individually exposed to an aqueous solution of hydrogen peroxide with a concentration of about 50-70%. Sodium nitrate was used as corrosion inhibitor. An accelerated storage test at 40° C. was performed. The content of metals in the hydrogen peroxide solution was determined. A higher metal content indicates a higher degree of corrosion. The original contents of metals in solution were in the aluminium test, 0.1 mg/l Al, and in the stainless steel test, 0.1 mg/l Fe.

| | | Phosphonate/ | | | | |
|---|---|---|---|---|---|---|
| Complex | Hydrogen | Phosphonic acid | Chloride | NaNO₃ | Aluminium | Stainless steel |
| forming | Peroxide (H₂O₂) | content | (mg Cl⁻/ | (mg NO₃⁻/ | 32 days | 32 days |
| agent | (wt %) | (mmol/kg H₂O₂) | kg H₂O₂) | kg H₂O₂) | Al (mg/l) | Fe (mg/l) |
| DTPMP | 50 | 0.71 | 20 | 0 | 17 | 1.7 |
| DTPMP | 50 | 0.71 | 20 | 220 | 2.3 | 1.3 |
| DTPMP | 50 | 0.87 | <0.4 | 0 | 1.3 | 2.6 |
| DTPMP | 50 | 0.87 | <0.4 | 220 | 1.4 | 3.2 |
| HEDP | 50 | 2.91 | <0.4 | 0 | 15 | 1 |
| HEDP | 72 | 0.81 | <0.3 | 150 | 13 | 2 |
| HEDP | 50 | 2.91 | <0.4 | 730 | 16 | 1.5 |
| ATMP | 50 | 1.67 | <0.4 | 0 | 5 | 0.5 |
| ATMP | 50 | 1.67 | <0.4 | 150 | 1 | 0.5 |
| ATMP | 50 | 1.67 | <0.4 | 730 | 1 | 0.1 |
| ATMP | 72 | 0.46 | <0.3 | 150 | — | 0.2 |
| ATMP | 72 | 1.16 | <0.3 | 510 | 0.3 | 0.13 |

It is concluded that the corrosion is lower for ATMP with low chloride content compared to DTPMP or HEDP with chloride content in similar range. It is also concluded that ATMP with low chloride content responds to added nitrate corrosion inhibitor. Neither DTPMP with low chloride content nor HEDP respond to nitrate.

EXAMPLE 2

The colour change was measured of hydrogen peroxide (70 wt %) compositions having a TOC value of about 300 mg/l with various contents of phosphonate (0.9-2.2 mmol DTPMP/kg H₂O₂, 1.2 -2.4 mmol ATMP/kg H₂O₂) and nitrate (500-600 mg NaNO₃/kg H₂O₂). The colour was measured according to a method in Swedish Standard, SS 028124-1985, where the colour value is corresponding to the colour of a certain amount of chloro platinate in an aqueous solution.

| | Phosphonate | |
|---|---|---|
| Complex forming | content | Colour |
| agent | (mmol/kg H₂O₂) | change |
| DTPMP | 0.9 | +10 |
| DTPMP | 2.2 | +10 |
| ATMP | 1.2 | 0 |
| ATMP | 2.4 | 0 |

It is concluded that the colour of a hydrogen peroxide composition with a high TOC value is unchanged when using ATMP in the composition.

1. An aqueous composition of, up to about 90 wt %, hydrogen peroxide, comprising from about 0.05 to about 20 mmol/kg H₂O₂ of amino tri (methylenephosphonic acid), or salts or degradation products thereof, and a corrosion inhibitor, being either substantially free from or containing less than about 0.1 mole/l chlorate ions, having a tin content from 0 to about 100 mg/kg H₂O₂, and having a chloride content less than about 10 mg Cl⁻kg H₂O₂.

2. Composition as claimed in claim 1, wherein the chloride content is from 0 to about 2 mg Cl⁻/kg H₂O₂.

3. Composition as claimed in claim 1, wherein the chloride content is from 0 to about 0.8 mg Cl⁻/kg H₂O₂.

4. Composition as claimed in claim 1, wherein the corrosion inhibitor is a nitrate salt.

5. Composition as claimed in claim 4, wherein the nitrate salt is an alkali metal nitrate or ammonium nitrate.

6. Composition as claimed in claim 4, wherein the nitrate content is from about 50 to about 1500 mg NO₃⁻/kg H₂O₂.

7. Composition as claimed in claim 4, wherein the nitrate content is from about 100 to about 700 mg NO₃⁻/kg H₂O₂.

8. Composition as claimed in claim 1, comprising from about 0.2 to about 4 mmol/kg H₂O₂ of amino tri (methylenephosphonic acid), or salts or degradation products thereof.

9. Composition as claimed in claim 1, comprising from about 5 to about 4000 mg/kg H₂O₂ of phosphoric acid.

10. Composition as claimed in claim 1, wherein the content of tin is from 0 to about 40 mg/kg H₂O₂.

11. Composition as claimed in claim 1, wherein the concentration of hydrogen peroxide is from about 10 to about 85 wt %.

12. An aqueous composition of, up to about 90 wt %, hydrogen peroxide, comprising from about 0.05 to about 20 mmol/kg H₂O₂ of amino tri (methylenephosphonic acid), or salts or degradation products thereof, an alkali metal nitrate or ammonium nitrate, from about 5 to about 4000 mg/kg H₂O₂ of phosphoric acid, being either substantially free from or containing less than about 0.1 mole/l chlorate ions, a tin content from 0 to about 100 mg/kg H₂O₂, and having a chloride content less than about 10 mg Cl⁻/kg H₂O₂.

13. Composition as claimed in claim 12, wherein the chloride content is from 0 to about 2 mg Cl⁻/kg H₂O₂.

14. Composition as claimed in claim 12, wherein the chloride content is from 0 to about 0.8 mg Cl⁻/kg H₂O₂.

15. Composition as claimed in claims 12, wherein the nitrate content is from about 50 to about 1500 mg NO₃₋/kg H₂O₂.

16. Composition as claimed in claim 12, wherein the nitrate content is from about 100 to about 700 mg NO₃₋/kg H₂O₂.

17. Composition as claimed in claim 12, comprising from about 0.2 to about 4 mmol/kg H₂O₂ of amino tri (methylenephosphonic acid), or salts or degradation products thereof.

18. Composition as claimed in claim 12, wherein the concentration of hydrogen peroxide is from about 10 to about 85 wt %.

19. A process for producing chlorine dioxide from hydrogen peroxide and metal chlorate, or chloric acid, comprising a step of feeding to a reaction zone metal chlorate or chloric acid and an aqueous composition of, up to about 90 wt %, hydrogen peroxide, the composition comprising from about 0.05 to about 20 mmol/kg H₂O₂ of amino tri (methylenephosphonic acid), or salts or degradation products thereof, and a corrosion inhibitor, being substantially free from or containing less than 0.1 mole/l chlorate ions, having a tin content from 0 to about 100 mg/kg H₂O₂, and having a chloride content less than about 10 mg Cl⁻kg H₂O₂.
